(19) United States
(12) Patent Application Publication
(10) Pub. No.: US 2005/0042035 A1
(43) Pub. Date: Feb. 24, 2005

(54) Offshore LNG regasification system and method

(76) Inventor: Jaap de Baan, Maassluis (NL)

Correspondence Address: Alan R. Thiele;Strasburger & Price, LLP, Suite 4300, 901 Main Street, Dallas, TX, 75202-3794, US

(21) Appl. No.: 10/922,634

(22) Filed: Aug. 20, 2004

Related U.S. Application Data
(60) Provisional application No. 60/497,290, filed on Aug. 22, 2003.

(51) Int. Cl. F17C 9/02; E02B 17/08; B63B 21/24

(52) U.S. Cl. 405/169; 405/172; 405/203; 114/293; 114/294

(57) ABSTRACT

A system and method for the offshore transfer of liquefied natural gas to a regasification plant is disclosed. Once the state of the natural gas has been changed from liquid to gas, the natural gas is conveyed to an onshore location.

This application claims the benefit of a Provisional U.S. Patent Application filed Aug. 22, 2003 and identified by Ser. No. 60/497,290.

### FIELD

The present invention pertains to the transport of natural gas; more particularly, the disclosed invention pertains to the regasification of natural gas transported in a liquid form by ocean-going tankers.

### BACKGROUND

Traditionally, tankers used to transport liquefied natural gas (LNG) are off-loaded in protected waters. Once reaching their destination, LNG tankers are typically moored alongside a quay where the connection of a quay-mounted articulated steel loading arm to the LNG tanker begins the off-loading process.

From a safety, efficiency, and cost standpoint, it would be desirable to both off-load the liquefied natural gas and transform it from a liquid state to a gaseous state at an offshore location. The natural gas, having now been transformed from a liquid state to a gaseous state, is then readily transportable by an existing system, such as through undersea pipelines as exist off the coast of the U.S., to an onshore location for temporary storage, further transport, processing, and/or use. Despite the increasing use and growing demand for natural gas in response to the escalating cost of oil, and the fact that the volume of natural gas being transported into the U.S. increases the need for an offshore off-loading and regasification system, no commercially viable system for the offshore off-loading and gasification of LNG is presently available.

Accordingly, a need remains in the art for a system and method which allows conventional LNG tanker vessels of any size or configuration to first moor at an offshore location and then discharge their cargo of liquefied natural gas, in its liquefied state, to a regasification plant. Once the LNG has been off-loaded, the LNG tanker vessel is then made ready to depart en route to pick up another load of LNG.

### SUMMARY

According to the present invention, a system is provided for the offshore off-loading of natural gas in a liquefied form together with a system for the offshore regasification of the liquefied natural gas. Once in a gaseous state, the natural gas is transportable by a conventional system, such as a pipeline, to an onshore location.

The disclosed system includes a mooring buoy or a mooring system for an LNG tanker vessel. Further included is the necessary pipe and pumping equipment to off-load the LNG from the tanker vessel to a regasification plant on another vessel. The natural gas having now changed state from liquid to gas is either transported to an offshore storage facility or an onshore distribution facility by means of a subsea pipeline.

### BRIEF DESCRIPTION OF THE DRAWING FIGURES

A better understanding of the offshore LNG off-loading and regasification system and method of the present invention may be had by reference to the drawing figures, wherein:

FIG. 1 is a perspective view of an LNG tanker vessel connected to another vessel including a regasification plant; and

FIG. 2 is a perspective view of a semi-submersible vessel which may be used for off-loading LNG at an offshore location.

### DESCRIPTION OF THE EMBODIMENTS

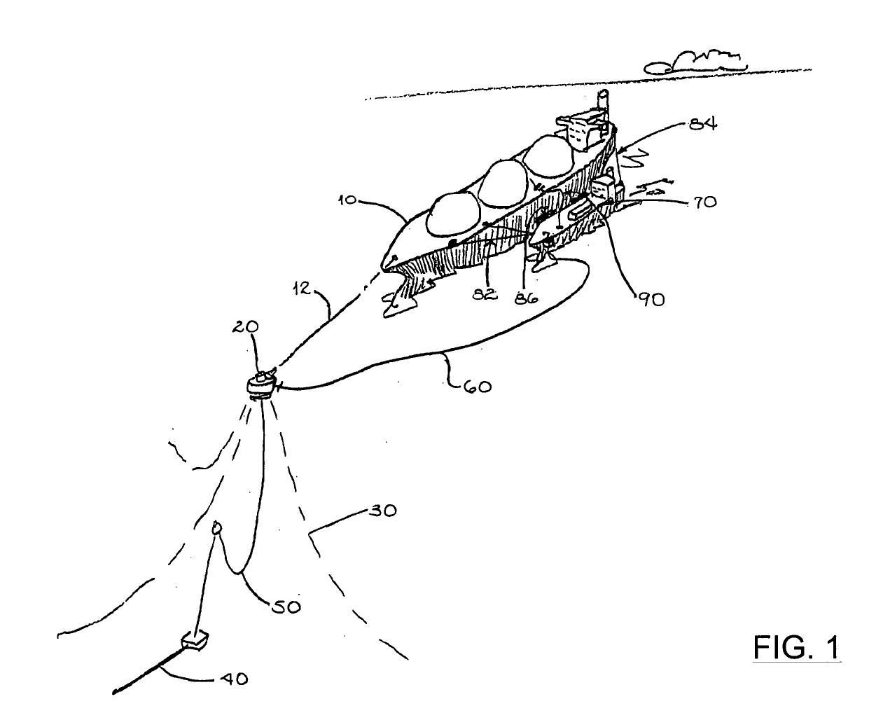

In the preferred embodiment of the invention as shown in FIG. 1, a large ocean-going vessel 10 is moored by a hawser 12 to a mooring apparatus, such as a CALM buoy 2. While a CALM buoy 20 is shown in FIG. 1, those of ordinary skill in the art will understand that a variety of different mooring systems, to include those which have come to be known as “single point mooring” systems, may be used without departing from the scope of the present invention.

The CALM buoy 20 is anchored to the seabed by anchor legs 30 and connected to a subsea pipeline 40 by a flexible riser 50. A floating hose 60 connects the CALM buoy 20 to a vessel 70 which includes a regasification plant. The vessel 70 including the regasification plant may be moored to the LNG tanker 10 using a traditional side-by-side multiple rope mooring arrangement 82, 84, 86. If the vessel 70 including the regasification plant is fitted with a dynamic positioning system, the traditional side-by-side rope mooring arrangement 82, 84, 86 can be omitted in favor of a system of computer-controlled thrusters. The system of computer-controlled thrusters can accurately maintain the position of the vessel 70 with respect to the LNG tanker vessel 10 or with respect to a predetermined point on the earth's surface.

According to the present invention, the transfer of LNG from the LNG tanker vessel 10 to the vessel 70 including the regasification plant is through a flexible pipe 90. By use of a system of heat exchangers which are part of the regasification plant on board the vessel 70, the temperature of the LNG is caused to increase from about −165° C. to about +5° C. This increase in temperature causes the LNG to change state from a liquid phase to a gaseous or a “dense gaseous” phase.

A pipeline and compressor system on board the regasification vessel 70 is used to raise the pressure of the natural gas to 1000-2000 psi. This pressurization of the natural gas on board the regasification vessel 70 is sufficient to enable the natural gas to flow through the flexible hose 60, through the CALM buoy 20, thence through riser 50 and pipeline 40 to an onshore location for temporary storage, further transport, processing, and/or use.

Upon completion of discharge of the liquefied natural gas from the LNG tanker vessel 10, the flexible pipe 90 is disconnected, the hose 60 is disconnected, and the side-by-side mooring arrangement is disconnected. The vessel 70 containing the regasification plant may return to an onshore location or may remain in the offshore area awaiting the arrival of another LNG tanker. Once having off-loaded a predetermined amount of LNG, the LNG tanker 10 departs to pick up a new cargo of LNG.

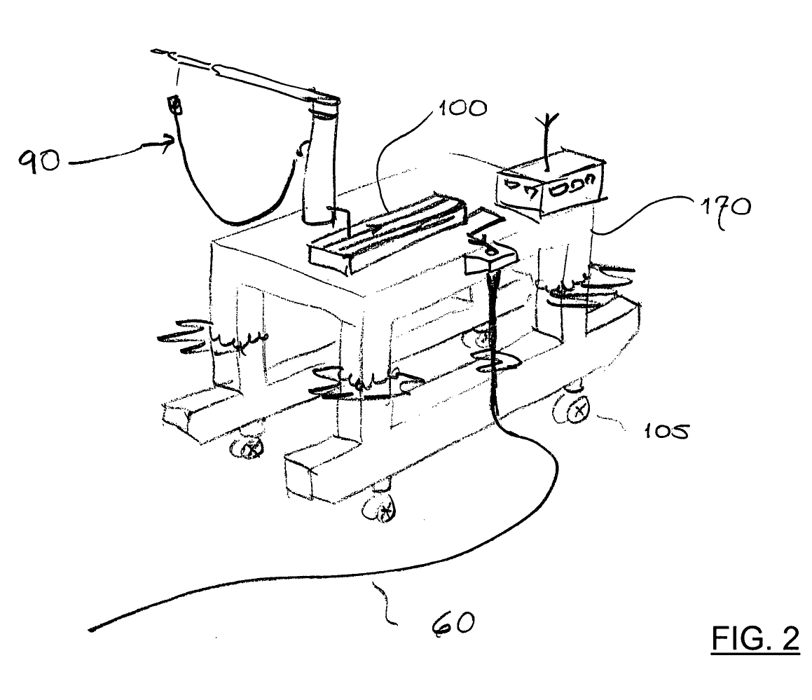

In another embodiment of the invention, as shown in FIG. 2, the large ocean-going LNG tanker may be connected to a semi-submersible vessel 170. The semi-submersible vessel 170, well known in the offshore drilling industry, is constructed to be located offshore at a substantially constant location. As with vessel 70, a system of computer-controlled thrusters 105 may be used.

As in the embodiment illustrated in FIG. 1, a flexible pipe 90 is used to transfer the LNG from the LNG tanker vessel. By the use of a regasification plant on board the semi-submersible vessel 170, the natural gas, once transformed into a gaseous or “dense gaseous” state, is then caused to flow through a flexible hose 60 into a system which permits the natural gas to flow to a conventional or existing natural gas transportation system.

While the disclosed system has been described according to a preferred and alternate embodiment, those of ordinary skill in the art will understand that numerous other embodiments have been enabled by the foregoing disclosure. Such other embodiments shall be included within the scope and meaning of the appended claims.

1. A system for the offshore transfer of liquefied natural gas from an LNG tanker to a system for moving the natural gas to an onshore location, said system comprising:
means for offshore mooring of an LNG tanker vessel;
a pipe for transferring LNG to a regasification plant, said regasification plant being located on a vessel positioned alongside the LNG tanker vessel;
a flexible hose providing a fluid connection from said regasification plant to a system for moving the natural gas to an onshore location.

2. The system as defined in claim 1 wherein said vessel is a semi-submersible vessel.

3. The system as defined in claim 1 wherein said vessel is moored to the LNG tanker vessel by ropes.

4. The system as defined in claim 1 wherein the position of said vessel with respect to the LNG tanker vessel is controlled by a dynamic positioning system.

5. The system as defined in claim 1 wherein said system for moving the natural gas onshore is a subsea pipeline.

6. The system as defined in claim 1 wherein said system for moving the natural gas onshore is a vessel constructed and arranged for moving natural gas in a gaseous state.

7. A method for the offshore transfer of natural gas from an LNG tanker vessel to system moving the natural gas to an onshore location, said method comprising the steps of:
mooring the LNG tanker vessel at an offshore location;
transferring the LNG to a degasification plant, said degasification being located on a vessel positioned alongside said LNG tanker vessel;
providing a flexible hose between said regasification plant and a system for moving the natural gas to an onshore location.

8. The method as defined in claim 7 wherein said vessel is a semi-submersible vessel.

9. The method as defined in claim 7 wherein said vessel is moored to the LNG tanker vessel by ropes.

10. The method as defined in claim 7 wherein the position of said vessel with respect to the LNG tanker vessel is controlled by a dynamic positioning system.

11. The method as defined in claim 7 wherein said system for moving the natural gas to an onshore location is a subsea pipeline.

12. The method as defined in claim 7 wherein said system for moving the natural gas onshore is a vessel constructed and arranged for moving natural gas in a gaseous state.
